(19) United States
(12) Patent Application Publication
(10) Pub. No.: US 2024/0177078 A1
(43) Pub. Date: May 30, 2024

(54) FLEET MANAGEMENT TOOLS FOR CHARGING STATION OPTIMIZATION

(71) Applicant: PowerFlex Systems, LLC, San Diego, CA (US)

(72) Inventors: Kellock IRVIN, San Francisco, CA (US); Zachary Jordan LEE, Altadena, CA (US)

(21) Appl. No.: 18/357,124

(22) Filed: Jul. 23, 2023

Related U.S. Application Data
(60) Provisional application No. 63/385,605, filed on Nov. 30, 2022.

(51) Int. Cl. G06Q 10/0631

(52) U.S. Cl. CPC G06Q 10/0631

(57) ABSTRACT

Certain aspects of the present disclosure provide techniques for managing a fleet of electric vehicles. An example method includes detecting a trigger event that affects charging characteristics of at least one vehicle in a fleet. The method also includes providing, via an interface, a prompt regarding the trigger event. The method includes presenting, via the interface, decisions to remedy the cause of the triggering event and consequences of the decisions to the charging characteristics of one or more vehicles in the fleet. Additionally, the method includes receiving, via the interface, an input accepting one of the decisions. The method includes providing instructions that affect the operation of at least one charging station based on the accepted decision.

### CROSS REFERENCE

This application claims the benefit of U.S. provisional application Ser. No. 63/385,605, filed on Nov. 30, 2022, which is hereby incorporated by reference in its entirety.

### INTRODUCTION

Aspects of the present disclosure relate to management of electric vehicle fleets and management of charging infrastructure to support the electrical vehicle fleets.

Electric vehicles (EVs), including plug-in hybrid and fully electric vehicles, are increasing in popularity around the world. It is expected that the proportion of new EVs sold each year out of the total number of vehicles sold will continue to rise for the foreseeable future. Moreover, while EV operators are primarily non-commercial at present (e.g., personal vehicles), commercial vehicle operators are increasingly adding EVs to their fleets for all sorts of commercial operations, thus adding to the number of EVs in operation throughout the world.

Management of fleets of electric vehicles and the charging infrastructure to support the fleets is challenging because of, in part, varying capabilities in electric vehicles within the fleet (e.g., battery capacity, battery recharge capability, range, on-board charging equipment compatibilities, etc.) and varying capabilities and availability of charging stations, such as electric vehicle supply equipment (EVSE). For example, different EVSE may have different levels (e.g., how much electric power can be delivered to the vehicle) and different plug-in interfaces. One challenge for fleet owners is assigning vehicles to tasks that require, for example, the vehicle to be able to travel a certain mileage. Additionally, because of internal constraints (e.g., matching electric vehicles with appropriate EVSE, etc.) and external constraints (e.g., cost and availability of power over charging period, etc.), it can be difficult for a fleet operator to understand the current status of the fleet and the effects that changes to the internal and external constraints will have on that status. While these challenges exists for both vehicle fleets of internal combustion engine (ICE)-powered vehicles as well as fleets of plug-in electric vehicles, the unique technological challenges inherent to plug-in electric fleets increase the difficulty of managing a fleet. For example, ICE-powered vehicles can refuel relatively quickly and can have a relatively long range. Recharging plug-in electric vehicles can be measured in hours and depends on what type of EVSE the vehicle is compatible with and whether a fast recharging EVSE is available. Replacing ICE-powered vehicle fleets with plug-in electric vehicle fleets has beneficial environmental impact. However, these technical problems inherent in plug-in electric vehicle technology limit the ability of plug-in electric vehicle fleets to replace ICE-powered vehicle fleets. As such, there is a need to overcome these challenges to manage electric vehicle fleets and charging infrastructure to support the electrical vehicle fleets so that adoption and use of environmentally beneficial EV vehicles can be accelerated.

### SUMMARY

Certain embodiments provide techniques for managing a fleet of electric vehicles. An example method includes detecting a trigger event that affects charging characteristics of at least one vehicle in a fleet. The method also includes providing, via an interface, a prompt regarding the trigger event. The method includes presenting, via the interface, decisions to remedy the cause of the triggering event and consequences of the decisions to the charging characteristics of one or more vehicles in the fleet. Additionally, the method includes receiving, via the interface, an input accepting one of the decisions. The method includes providing instructions that affect the operation of at least one charging station based on the accepted decision.

Other embodiments provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts an example session management system that manages a fleet of electric vehicles and charging stations.

FIG. 2 illustrates an example interface to facilitate management of a fleet of electric vehicles by a fleet operator.

FIG. 3 is a flowchart of an example method to manage a fleet of electric vehicles in response to a trigger event.

FIG. 4 is a flowchart of an example method to react to changes that impact charging strategies for a fleet of electric vehicles.

FIG. 5 is a flowchart of an example method to optimize changes in charging strategies for a fleet of electric vehicles.

FIG. 6 depicts an example processing system configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for management of electric vehicle fleets and management of charging infrastructure to support the electrical vehicle fleets.

Managing a fleet of electric vehicles is challenging due to present characteristics of electric vehicle technology. One challenge is recharging time. Internal combustion engine (ICE) vehicles can refuel in a timeframe measured in minutes. However, electric vehicles recharge in a timeframe measured sometimes in hours. This makes managing a fleet of electric vehicles technologically different than managing a fleet of ICE vehicles.

Fleet management generally includes assigning jobs to vehicles and electric vehicle supply equipment (EVSE) (sometimes referred to herein as “charging stations”) to recharge the vehicles such that they are capable of performing the assigned job at the requested time. For example, a job may be a delivery route or a car rental period, etc. where the electric vehicle needs to have a minimum range (e.g., a minimum SoC to support a range) by a deadline (e.g., the start of the rental period, the start of the delivery route) with a certain capacity (e.g., capacity for four passengers, cargo capacity of twenty cubic feet, etc.).

Another challenge of managing a fleet of electric vehicles is determining which charging station at a charging site will satisfy the charging task associated with the job assigned to the electric vehicle. Because the electric vehicle fleet may be composed of vehicles of different makes and models, management of the fleet has to account for different vehicle attributes that are relevant both to job assignment and charging tasks that support those job assignments. Similarly, charging stations may have different power levels that affect a maximum charging rate and different connectors to accommodate the different makes and models. For example, while most vehicles in the United States are compatible with the J1772 standard for level-2 AC charging, vehicles may only be compatible with a Combined Charging System (CCS) connector or a “CHArge de MOve” (CHAdeMO) connector for level-3 DC charging. In addition, the parking stalls near the charging stations may have geometric constraints that limit which vehicles can charge at them, i.e., size of the parking space or length of the charging cord. Additionally, because some charging sites have limited power availability, the fleet management system for a fleet of electric vehicles may have to consider congestion in the charging network. For example, the charging site may not have enough power available to charge all electric vehicles at a high charging rate even if enough high level charging stations are available.

Due to the dynamic nature of fleet management, it can be difficult to understand the implications of internal changes and external changes to factors that contribute the readiness of the electric vehicles in a fleet (e.g., the readiness to complete jobs assigned to vehicles in the fleet). These internal changes may include, for example, changes to availabilities of electric vehicles and/or charging stations and/or changes to job assignments, etc. External changes may include, for example, changes in power availability and/or charging costs, etc. These difficulties are magnified because of, for example, the unique issues described above of managing and charging electric vehicles. For example, refueling an ICE fleet vehicle with gasoline has a nominal impact on a vehicle's schedule, but charging an electric fleet vehicle has relatively large impacts on vehicle schedules. As such, the positive feedback loop of schedule disruptions is generally more impactful to fleets of electric vehicles than it is to fleets of ICE vehicles.

Fleet operators are responsible for getting vehicles ready for jobs. Electric vehicle charging introduces a complicated web of relationships between vehicles, charging stations, power consumption, and power availability that is impossible for a fleet manager to manage in their head (e.g., as a mental process) or to intuitively understand the implications of any given decision. Schedule disruptions caused by these issues and the lack of effective tools to manage electric vehicle fleets are a long-standing industry technical problem. As described herein, fleet management tools for charging station optimization provide a tool to facilitate understanding and implementing changes to charging strategies of the fleet of electric vehicles.

Generally, operators of EV fleets may operate one or more charging sites that include charging stations. The fleet operators are responsible for servicing vehicles and insuring vehicles assigned to particular jobs have a minimum SoC by a certain time that the job is scheduled to commence (sometime referred to as a “charging deadline”). As described herein, to assist the fleet operator, an electric vehicle fleet management system (EVFMS) and one or more charging management systems (CMS) assist managing the fleet of vehicles.

For example, the EVFMS matches electric vehicles to jobs and charging stations by, for example, operating an optimization algorithm that considers the characteristics of jobs (e.g., a deadline and a minimum state of charge (SoC), necessary vehicle attributes for the job, etc.), the characteristics of the electric vehicles in the fleet (e.g., current location, make, model, passenger capacity, cargo capacity, towing capacity, current SoC, current maintenance needs, cleaning needs, mileage, maximum charging rate, connector compatibility, etc.), and the characteristics of the charging stations (e.g., current location, charging level and/or maximum power output, connector type and characteristics, and/or the space available for a vehicle to park in the vicinity of the charging station, etc.) to assign an electric vehicle to a job and a charging station in order to meet the charging deadline for the job.

The CMS manages power delivery to charging stations to meet the charging deadlines of the vehicles and manage power usage at one or more associated charging sites. The fleet management tools provide a fleet level interface to interact with the EVFMS and/or the CMS and to understand the current status of the vehicles in the fleet. In some examples, the fleet operators may desire to change the charging strategy of a certain vehicle or change priorities of an optimization algorithm (e.g., operated by the EVFMS, etc.). In such examples, the fleet management tools facilitate, through visual feedback, understanding the effects of the change to the other vehicles in the fleet. In some examples, EVFMS may request feedback through the fleet management tools when not all vehicles can meet their respective charging deadlines due to resource limitations and/or dynamic events.

As described below, in some examples, the fleet management tool (i) monitors (e.g., via the EVFMS and/or the CMS) the status of vehicles in the fleet, (ii) prompts a user and provides textual, audio, and/or visual context about situations that affect vehicles meeting charging deadlines, (iii) presents decisions for the fleet operator to make to remedy the situation, (iv) summarizes potential implications of each presented decision, (v) receives input of a decision from the fleet operator, and (vi) communicates that decision back to the EVFMS and/or the CMS to cause instructions to be sent to affected parts of the system (e.g., charging stations, vehicles, etc.) to implement the decision.

For example, the fleet management tool may determine that a vehicle will not meet its target SoC by the deadline set by the job it has been assigned (e.g. the “situation”). The fleet management tool may present an interface (e.g., via an app, etc.) or otherwise notify the fleet operator (e.g., via text message, via an email, push notification, etc.) of the situation. The fleet management tool may graphically present decisions or options (e.g., accept delay, increase energy provided to the vehicle, etc.) and present the fleet-wide effects associated with the decisions (e.g., delay in charging other vehicles, increase in cost, etc.). The fleet-wide effects may be the result of the EVFMS and/or the CMS re-optimizing the system with the presented decisions as inputs. The fleet management tool may then receive selection of one of the decisions from the fleet operator (e.g., via the interface, via a text message, etc.). The fleet management tool may then communicate the decision to the EVFMS and/or the CMS to cause the decision to be implemented.

### Terminology Used Herein

As used herein, an “optimization configuration” refers to the configuration used by the EVFMS to operate the optimization algorithm including the charging stations to be controlled, topology of the charging site(s), and which optimization strategies (objectives and constraints) are active.

As used herein, “optimization context” describes the current state of the charging sites, including charging session parameters, historical values of load and generation, actual SoC for vehicles, and forecasts of future load, generation, and charging sessions.

As used herein, “optimization strategy” refers to an objective function and set of constraints describing what the parameters of optimization. Examples include minimizing energy costs, minimizing demand peaks, meeting charging session demands, or penalizing quick changes in controllable values (for smoothing). The optimization strategy may be, for example, managed through the fleet management tools.

As used herein, a “base configuration” refers to a combination of optimization configuration and optimization context which describes the current state of the fleet of vehicles.

As used herein, an “alternative configuration” refers to a combination optimization configuration and optimization context which describes the state of the system after some action is taken. This may include adding a strategy or piece of equipment, adjusting a charging session parameter, adding a new charging session, adjusting the parameters of an existing strategy (e.g., via the fleet management tools).

As used herein, “charging strategy” refers to a sequence of charging rates in current or power which describe how a vehicle is scheduled to charge over time.

As used herein, a “charging complete time” refers to the last time when the vehicle drew energy from the charging station. As used herein, “successful charging session” refers to a charging session in which the vehicle's energy demand was met by its deadline (e.g., the energy delivered to the vehicle met or exceeded the energy target for the session and the done charging time is before the session deadline).

As used herein, an “earliest feasible departure” refers to an earliest time when the charging site is capable of delivering a particular vehicle's energy demand to reach its SoC target disregarding whether it causes other vehicles to not reach their SoC target energy demand by their deadline.

As used herein, an “earliest energy-aware departure” refers to an earliest time when the charging site is capable of delivering a particular vehicle's energy demand to reach its SoC target demand without reducing the energy delivered to other vehicles by more than a reduction threshold (e.g., 10%, 20%, etc.).

As used herein, an “earliest timeline-aware departure” refers to an earliest time when the charging site is capable of delivering a particular vehicle's energy demand to reach its SoC target without increasing the finished charging time or other vehicles by more than a delay threshold (e.g., 5 minutes, 10 minutes, 20 minutes, etc.).

As used herein, an “earliest cost-aware departure” refers to an earliest time when the charging site is capable of delivering a particular vehicle's energy demand to reach its SoC target without increasing the total cost of charging by more than a cost threshold (e.g., 1%, 5%, 10%, etc.).

As used herein, a “max energy delivered [energy-aware]” refers to a maximum amount of energy the charging station could deliver to the vehicle before the session deadline without reducing the energy delivered to other vehicles by more the reduction threshold (e.g., 10%, 20%, etc.).

As used herein, a “max energy delivered [timeline-aware]” refers to a maximum amount of energy the charging station is capable of delivering to the vehicle before the session deadline without increasing the finished charging time of other vehicles by more than the delay threshold (e.g., 5 minutes, 10 minutes, 20 minutes, etc.).

As used herein, a “max energy delivered [cost-aware]” refers to a maximum amount of energy the charging station is capable of delivering to the vehicle before the session deadline without increasing the total cost of charging by more than the cost threshold (e.g., 1%, 5%, 10%, etc.).

As used herein, a “cost delta” refers to a difference between the total resource cost (e.g., energy consumption, delay, money, etc.) of the base configuration compared to the alternative configuration. As used herein, the “actual financial cost” refers to the actual cost of applying the results of an optimization in terms of money paid to operate the system minus revenues from the system. As used herein, the “real cost delta” refers to the difference in the actual financial cost of the base configuration compared to the alternative configuration.

### Example Fleet Management System

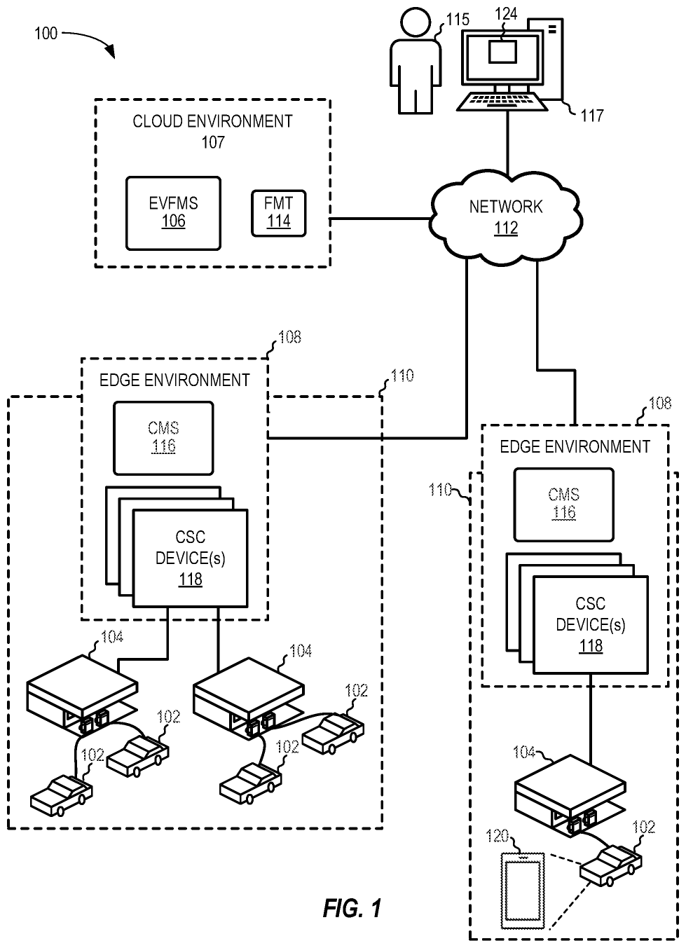

FIG. 1 depicts an example fleet management system 100 that manages a fleet of electric vehicles 102 and charging stations 104. In the illustrated example, the fleet management system 100 includes an electric vehicle fleet management system (EVFMS) 106 operating in a cloud environment 107 communicatively coupled to one or more edge environments 108 to manage the fleet of electric vehicles 102 and the charging stations 104 at charging sites 110. In the illustrated example, the EVFMS 106 and the edge environments 108 are coupled via a network 112. The fleet management system 100 also includes one or more fleet management tools (FMT) 114 to provide an interface to a fleet operator 115 to directly or indirectly interact with the EVFMS 106 and to communicate the status of the vehicles 102 in the fleet being managed and, in some examples, the charging stations 104 at the charging sites 110 being managed. The FMT 114 may present the interface on an application operating on a computing device 117 (e.g., a smartphone, a tablet, a laptop, a workstation, other smart devices, etc.).

In the illustrated example, each charging site 110 includes charging stations 104 that are coupled to the edge environment 108. The charging sites 110 include multiple charging stations 104 that are geographically co-located and share access to resources (e.g., power, parking spaces, etc.). For example, a charging site 110 may have a limited amount of power that it may use at any one time (sometime referred to as its “power capacity”). Often, the charging stations 104 at charging sites 110 have different capabilities and/or connection types to facilitate charging vehicles of different makes and models. For example, the charging sites 110 may include charging stations that vary by (i) levels (e.g., as set forth in SAE J1772), (ii) maximum power (e.g., 1.9 kilowatts (KW), 6.6 kW, 19.2 kW, etc.), (iii) the current type (e.g. alternating current (AC), direct current (DC)), (iv) connector types (e.g., a SAE J1772-compliant connector, a CSS connector, a ChadeMo connector, etc.), (v) cord length, (vi) parking space attributes (e.g., sized for compact vehicles, standard vehicles, or cargo vehicles, accessible parking spaces, etc.), and/or (vii) charging stations 104 that are reserved for a particular purpose or department, etc.

The edge environment 108 is configured as an interface between the charging stations 104 at the corresponding charging site 110 and cloud environment 107. The edge environment 108 may serve as a communication hub between equipment located at the charging site 110 (e.g., the charging stations 104, energy sources, batteries, etc.). The edge environment 108 may also handle local control and/or coordinate control of the devices with services operating in the cloud environment 107. In some examples, the edge environment 108 is configured such that the charging stations 104 may be controlled dynamically (e.g., increased or decreased, limited, etc.) and may be configured to provide fast processing of data, as well as processing when access to the network 112 is limited or unavailable.

In the illustrated example, the edge environment 108 includes a charging management system (CMS) 116 and one or more charging station control (CSC) devices 118. The CMS 116 manages charging sessions and manages power utilization by the charging stations 104. The CMS 116 may control multiple charging stations 104 at the charging site 110 provide charging to the vehicles 102 while balancing power capacity of the location by, for example, defining pilot signals among multiple vehicles 102 to shape the power utilization of the charging site 110. For example, when a vehicle 102 plugs into one of the charging stations 104, the charging station 104 sends a message to the CMS 116, the CMS 116 identifies the particular vehicle 102, and provides a pilot signal to be used to implement a charging strategy for the vehicle 102 (e.g., based on a minimum SoC and charging deadline assigned to the vehicle 102, etc.). In some examples, the CMS 116 receives telematics data from the vehicles 102, regardless of whether the vehicle 102 is present at charging site 110 (e.g., while in transit, etc.). In some such examples, the vehicles 102 may be communicatively coupled (e.g., via a cellular connection) to a telematics system. The vehicle 102 (e.g., via a telematics control unit, etc.) provides operational data (e.g., location data, SoC data, speed data, etc.) to the telematics system and the telematics system provides or otherwise makes available the operational data to the CMSs 116. The operational data may also be provided to the EVFMS 106 to facilitate incorporating the operation data the analysis of the vehicles 102 in the fleet as described herein (e.g., to anticipate when a vehicle 102 will arrive at a charging site 110 and/or the SoC of the vehicle 102 when it arrives, etc.). In the illustrated example, each edge environment 108 includes a CMS 116 that manages the power capacity at the corresponding charging site 110. In some embodiments, the CMS 116 reside in the cloud environment 107 and may control the power utilization at multiple charging sites 110.

The CSC devices 118 may be physically installed within communications range of the charging station 104. The CSC devices 118 (sometimes referred to as “core devices” or “multimodal communication devices”) are central processing devices that serve as a communications hub to provide optimization, load management, communication coordination, and data historian services in coordination with services, such as the EVFMS 106 and/or CMS 116, operating in the edge environment 108 and/or the cloud environment 107. The CSC devices 118 may support communicating with the charging stations 104 through one or more local network protocols (e.g., Wi-Fi, ZigBee®, Ethernet, etc.) using one or more communication protocols (e.g., ModBus, DNP3, OCPP, OCPI, etc.).

The cloud environment 107 may provide dynamic hosting of services operating on one or more virtual and/or physical servers (e.g., virtualized servers, virtualized containers, physical hardware, etc.). In the illustrated example, the EVFMS 106 and the FMT 114 operate in the cloud environment 107 as services or a set of services to manage the fleet of vehicles 102 as described herein.

The EVFMS 106 monitors and manages the fleet of the vehicles 102 to assign jobs and the charging stations 104 to the vehicles 102. The EVFMS 106 matches the vehicles 102 to jobs and the charging stations 104 at a charging site 110 based on, for example, characteristics of the vehicles 102 (e.g., current SoC, passenger or cargo capacity, maximum charging rate, connector type, etc.), job requirements (e.g., charging deadlines, minimum SoC targets, passenger or cargo capacity, etc.), characteristics of the charging stations 104 at the charging sites 110 (e.g., connector type, maximum power output, etc.) and/or power availability at the charging sites 110. The EVFMS 106 may dynamically assess jobs and/or charging stations 104 because the jobs, vehicles, charging stations, and power availability may change over time. For example, jobs may be added at any point and/or deadlines may change, vehicles become available or unavailable at any time, and/or there may be changes in the power capacity at a charging site 110, etc.

In some examples, the EVFMS 106 may employ an optimization strategy to assign and, subsequently evaluate assignments of vehicles 102 to jobs and charging stations 104. To evaluate the assignments of vehicle 102, the EVFMS 106 may use charging data collected from the charging stations 104, telematics data collected from the vehicle 102, power data collected from the CMS 116, and/or other data received from other service providers (e.g., power generation companies, weather information providers, traffic data providers, etc.) retrieved via application programming interfaces (APIs). In some examples, the optimization strategy uses an optimization algorithm based on solving a mixed integer program with various constraints that apply penalties that reflect the preferences/priorities of a fleet operator 115, such as penalties for moving a vehicle 102 between charging stations 104, and penalties for changing a job assigned to the vehicle 102, etc. In some examples, the optimization algorithm is a rules-based algorithm that implements a rule-based assignment approach. The rule-based method allows the optimization algorithm to be configured by selecting a set of rules and parameters to meet the priorities/preferences of the fleet operator 115. In some examples, the optimization algorithm is based on a machine learning algorithm that uses a parameterized function trained based on a dataset that reflects the priorities/preferences of the fleet operator 115.

The EVFMS 106 may, from time-to-time, evaluate/reevaluate the charging status of the vehicles 102 in the fleet (e.g., whether each of the vehicles 102 in the fleet will have a successful charging session) and/or which vehicles 102 are assigned to which jobs and/or to which charging stations 104. For example, when the power capacity of the charging site 110 changes, a vehicle 102 arrives at the charging site 110, and/or a new job is added to be assigned to a vehicle 102, the EVFMS 106 may use the optimization strategy to evaluate the effects on the vehicles 102 at the charging site 110. As another example, the EVFMS 106 may receive (e.g., via the FMT 114) a request that affects a particular vehicle and/or a setting that affects the optimization algorithm. During this reevaluation process, the EVFMS 106 may (i) identify one or more vehicles 102 that will not have a successful charging session, (ii) identify changes to the charging session of the one or more vehicles 102, and (iii) determine effects that these changes will have on the other vehicles 102 in the fleet. In some examples, when the EVFMS 106 identifies one or more vehicles 102 that will not have a successful charging session, the EVFMS 106 may send an alert to, for example, the fleet operator 115 (e.g., via the FMT 114) and/or a driver associated with the vehicle (e.g., via text message, instant message, email, etc.). Upon receiving input from a fleet operator 115, the EVFMS 106 may directly or indirectly cause the change to be implemented. In some examples, the EVFMS 106 may instruct the CMS 116 associated with the charging site 110, the affected vehicles 102 (e.g., via autonomous control units associated with the affected vehicles 102, etc.), and/or provide instructions and notifications to a driver associated with the vehicle 102 (e.g., via a mobile devices 120, an infotainment center of the vehicle 102, etc.) to perform actions to implement the change. In some examples, the EVFMS 106 may change configuration files to implement the decision made by the fleet operator 115. For example, the EVFMS 106 may change a charging deadline of a vehicle in a fleet-wide configuration file and the CMS 116 may implement a charging strategy for the vehicle 102 based on the charging deadline based on the fleet-wide configuration file.

If one or more vehicles 102 do not have a successful charging session, the EVFMS 106 may determine decisions or options to ameliorate or minimize the effects to the vehicles 102. In some examples, the decisions or options are presented as changes to the minimum SoC target and/or the charging deadline. In some examples, the EVFMS 106 may identify decisions or options based on the earliest feasible departure of the affected vehicles 102, the earliest energy-aware departure of the affected vehicle 102, the earliest timeline-aware departure of the affected vehicles 102, and/or the earliest cost-aware departure of the affected vehicles 102.

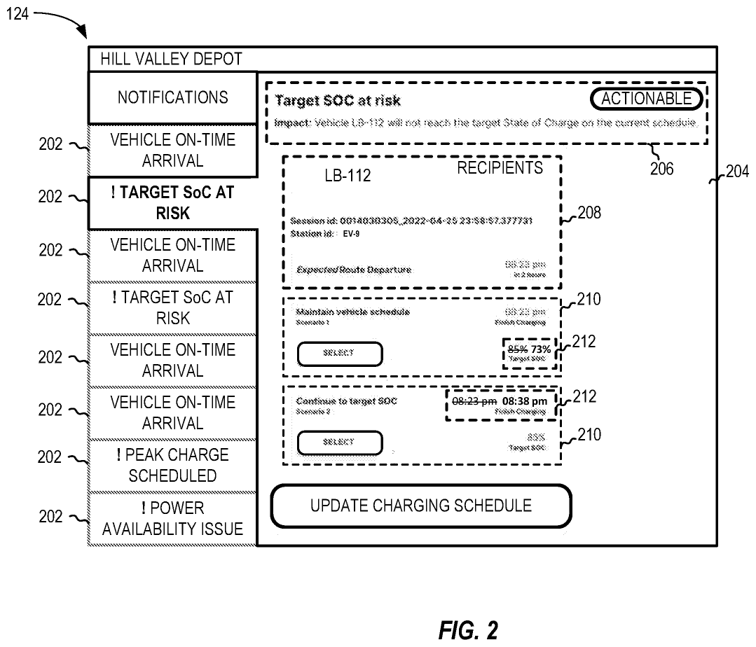

The FMT 114 provides an interface 124 to facilitate interaction between the EVFMS 106 and the fleet operator 115 in a manner to facilitate understanding of the status of the fleet of vehicles 102 by the fleet operator 115 and to receive input from the fleet operator 115. FIG. 2 illustrates an example of the interface 124.

### Example Fleet Management Interface

In the illustrated example of FIG. 2, the interface 124 presents a list of status fields 202. The status fields 202 display an overview of the vehicles 102 in the fleet. When the EVFMS 106 indicates an alert, the FMT 114 provides an overview of the nature of the alert in the status fields 202. Interacting with one of the status fields 202 causes the FMT 114 to display the corresponding status screen 204 that provides a detailed account of the status of the corresponding vehicle 102. In the illustrated example, the status screen 204 includes a status summary field 206 and a vehicle identification field 208. When an alert is present, the status screen 204 may include one or more decision fields 210.

The status summary field 206 provides a summary of the operational condition of the vehicle 102. In some examples, the status summary field 206 provides a summary of the condition causing the alert and information regarding the impact of the condition on the charging deadline of the vehicle 102.

The vehicle identification field 208 includes information (e.g., name, session identifier, charging station identifier, job details, charging deadline, etc.) to identify the vehicle 102 causing the alert.

The decision fields 210 provide the options generated by the EVFMS 106 to address the condition that caused the alert. The decision field 210 includes an effect field 212 that displays the effect that selecting the corresponding option will cause to the operational conditions of the vehicle 102. In some embodiments, the decision field 210 may also display the effect that selecting the corresponding option will cause to the operation conditions of other vehicles in the fleet. Selecting on the decision fields 210 will convey the input of the fleet operator 115 to the EVFMS 106. The EVFMS 106 may then issue instructions to cause the decision to be implemented.

In some examples, the status screen 204 includes entry fields to facilitate entry, by the fleet operator 115, of desired changes to the operation of the vehicle 102 (e.g., manual changes in charging deadline, manual changes to target SoC, changes to charging station assignment, etc.).

### Example Method for Managing Trigger Events

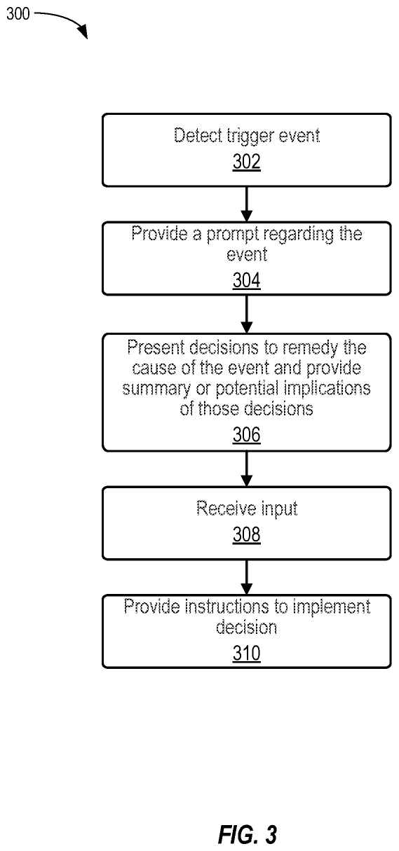

FIG. 3 is flowchart of an example method 300 to manage a trigger event indicative of a negative status condition of a vehicle 102 in a fleet. In some embodiments, method 300 may be performed by an FMT, such as FMT 114 of FIG. 1.

Method 300 begins at step 302 when a trigger event is detected. A trigger event may be detected, for example, when an EVFMS (e.g., the EVFMS 106 of FIG. 1) determines that (i) a vehicle (e.g., one of the vehicles 102 of FIG. 1) will not meet the minimum SoC by the charging deadline, (ii) the vehicle 102 is late to the scheduled charge period, (iii) the vehicle 102 is scheduled to charge during a peak time-of-use (TOU) period, (iv) the vehicle 102 is below a set threshold while in the field, and/or (v) the charging site (e.g., one of the charging sites 110 of FIG. 1) is going to set a new demand peak and/or is going to exceed the power capacity of the charging site 110, etc.

Method 300 continues at step 304 with providing a prompt, via a notification, regarding the trigger event to, for example, the fleet operator. In some examples, the prompt is provided by the FMT via the interface 124 of FIG. 2 (e.g., using the status fields 202 of FIG. 2). Additionally or alternatively, in some examples, the prompt may be provided by another communication method, such as a text message or an email, etc.

Method 300 continues at step 306 with presenting decisions to remedy the cause of the event and provide summary or potential implications of those decisions. For example, the decisions and the implications of the decisions may be provided by the interface (e.g., via the decision fields 210 and the effect fields 212 of FIG. 2). The presented decisions and the implications may be determined, for example, by an EVFMS monitoring the statuses of the vehicles in the fleet and and/or optimizing the job and charging station assignments of the vehicles in the fleet. The decisions can be made to mitigate the consequences of the situation that is causing the event. The decisions may include, for example, shifting the time period a vehicle(s) charge with respect to energy, timeline, and greenhouse gas costs, shifting charging prioritization, shifting the delivery (amperage) of the power, and, taking no action. The decisions may be made in light of priorities set by, for example, the fleet operator (e.g., decisions that reflect the earliest feasible departure, the earliest energy-aware departure, the earliest timeline-aware departure, and/or the earliest cost-aware departure, etc.). For example, if the vehicle will not meet the minimum SoC by the charging deadline, the presented decision may be accepting the lower SoC to meet the charging deadline and delaying the charging deadline to meet the minimum SoC.

Method 300 continues at step 308 with receiving an input from, for example, the fleet operator indicating which of the decisions presented at step 306 has been chosen.

Method 300 continues at step 310 with providing, for example, by the EVFMS 106, instructions for implementing the decision selected at step 308.

Note that FIG. 3 depicts one example of a method 300, but others are possible, which may include additional, fewer, or alternative steps consistent with the various methods described herein.

### Example Method Manage Events that Affect a Fleet of Vehicles

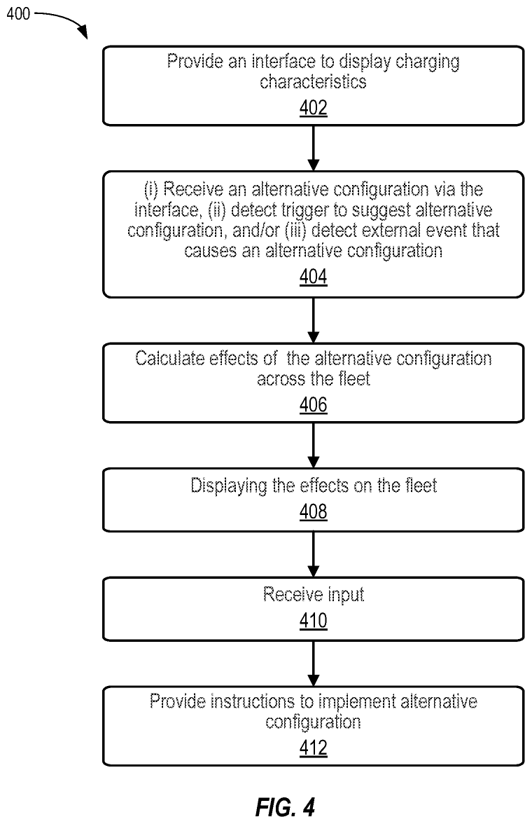

FIG. 4 is flowchart of an example method 400 to manage events that affect a vehicle 102 in a fleet. In some examples, method 400 may be performed by an FMT and/or an EVFMS, such as the FMT 114 and the EVFMS 106 of FIG. 1.

Method 400 begins at step 402 with providing an interface to display charging characteristics of the vehicles in a fleet (e.g., the vehicles 102 of FIG. 1). The charging characteristics may include, for example, current SoC, minimum SoC target, charging deadline, current power consumption, and/or current assigned charging station, etc. For example, the FMT 114 may provide the charging characteristics via the interface 124 of FIG. 2.

Method 400 continues at step 404 with detecting an event or trigger that may cause a change in the status of one or more of the vehicles in the fleet. In some examples, the event or trigger may be receiving an alternative configuration to one or more of the charging characteristics at least one vehicle in the fleet (e.g., via the interface). For example, the fleet operator may desire to change the charging station (e.g., one of the charging stations 104 of FIG. 1) that is assigned to a vehicle in the fleet. In some examples, the event or trigger may be a suggestion, for example, by the EVFMS of another configuration to one or more of the charging characteristics at least one vehicle 102 in the fleet. For example, the EVFMS may detect that a vehicle in the fleet is going to miss a scheduled charge period and may suggest a new charge period. In some examples, the trigger or event may be an external event that causes an alternative configuration to one or more of the vehicle in the fleet. For example, the EVFMS may detect that the power capacity of the charging site (e.g., one of the charging sites 110 of FIG. 1) is changing, the cost of power is changing, and/or the charging station is entering a peak TOU period.

Method 400 continues at step 406 with calculating the effects to the charging characteristic caused by the alternative configuration to the vehicles 102 in the fleet. For example, the EVFMS 106 may determine if any vehicle 102 in the fleet will not achieve the minimum target SoC by a charging deadline, if the cost to meet the minimum target SoC by the charging deadline exceeds a cost threshold, or if power consumption to meet the minimum target SoC by the charging deadline exceeds a power threshold, etc.

Method 400 continues at step 408 with displaying or otherwise communicating the effects calculated at step 406 to, for example, the fleet operator. In some examples, the effects are displayed via the interface managed by the FMT.

Method 400 continues at step 410 with receiving an input from, for example, the fleet operator indicating to implement the alternative configuration.

Method 400 continues at step 412 with providing, for example, by the EVFMS, instructions for implement the decision selected at step 308.

Note that FIG. 4 depicts one embodiment of a method 400, but others are possible, which may include additional, fewer, or alternative steps consistent with the various methods described herein.

### Example Method for Managing Charging Strategies of Vehicles in a Fleet

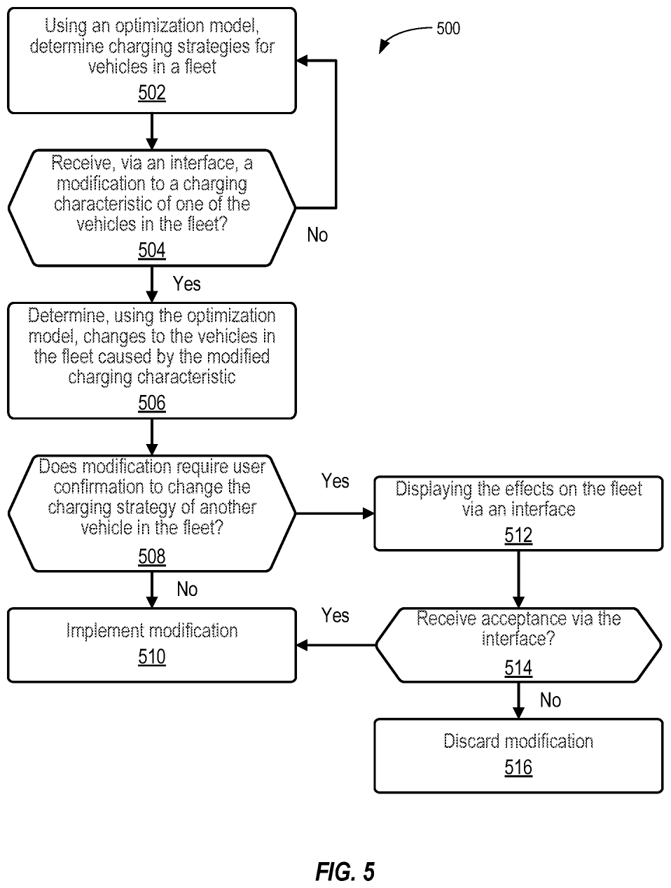

FIG. 5 is flowchart of an example method 500 to manage charging strategies of vehicles 102 in a fleet. In some examples, method 500 may be performed by an FMT and/or an EVFMS, such as the FMT 114 and the EVFMS 106 of FIG. 1.

Method 500 begins at step 502 with using an optimization model to determine charging strategies for vehicles in a fleet (e.g., the vehicles 102 of FIG. 1). The optimization model may, for example, assign vehicles in the fleet to jobs in a job queue and to charging stations (e.g., the charging stations 104 of FIG. 1) based on the characteristics of the vehicles, requirements of the jobs, and characteristics of the charging stations. The optimization model may, for example, maximize the number of vehicles in the fleet that are able to meet the minimum SoC target by the charging deadline as specified by assigned job.

The method continues at 504 with determining whether a modification to the charging characteristics of one or more vehicles in the fleet has been received via an interface. For example, the fleet operator (e.g., the fleet operator 115 of FIG. 1) may input a modification to a minimum SoC target or request the earliest feasible departure of one or more vehicles in the fleet via an interface (e.g., the interface 124 of FIG. 1 and FIG. 2) provided by the FMT.

When a modification has not been received, method 500 returns to step 502 with using an optimization model to determine charging strategies for vehicles in a fleet.

When a modification has been received, the method continues to step 506 with determining, using the optimization model, changes to the vehicles in the fleet caused by the modified charging characteristic.

The method continues at step 508 with determining whether the modification user confirmation of the charging strategy of any vehicle in the fleet. A modification may require user confirmation when, for example, the modification causes a negative consequence by causing at least one vehicle in the fleet to not charge to a minimum SoC by the charging deadline of the job assigned to the vehicle. In some examples, a modification may require user confirmation when the modification affects the charging deadline or the minimum SoC target. In some examples, the FMT may maintain a list of characteristics (e.g., charging deadline, minimum SoC target, charging station assignment, charging start time, etc.) that, if changed by the modification, require user confirmation.

When the modification does not cause negative consequences to the charging strategy of any vehicle 102 in the fleet, method 500 continues at step 510 with implementing the modification.

When the modification causes negative consequences to the charging strategy of any vehicle 102 in the fleet, method 500 continues at step 512 with displaying the effects on the vehicles 102 in the fleet via an interface. For example, the effects may be displayed via the interface provided by the FMT, as described above with respect to FIG. 2.

Method 500 continues at step 514 with determining whether acceptance has been received via the interface. For example, the fleet operator may accept changes caused by the modification via the interface provided by the FMT.

When acceptance has not been received, method 500 continues at step 516 with discarding the modification without implementing it.

When acceptance is received, method 500 continues at step 510 with implementing the modification.

Note that FIG. 5 depicts one example of a method 500, but others are possible, which may include additional, fewer, or alternative steps consistent with the various methods described herein.

### Example Processing System for Optimizing Charging of Electric Vehicles Based on Vehicle Telematics

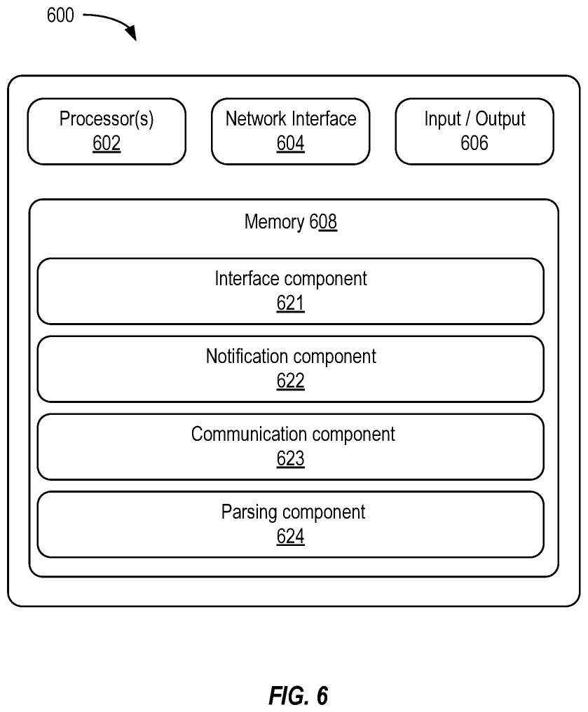

FIG. 6 depicts an example processing system 600 configured to perform the methods described herein.

Processing system 600 includes one or more processors 602. Generally, a processor 602 is configured to execute computer-executable instructions (e.g., software code) to perform various functions, as described herein.

Processing system 600 further includes a network interface 604, which generally provides data access to any sort of data network, including personal area networks (PANs), local area networks (LANs), wide area networks (WANs), the Internet, and the like.

Processing system 600 further includes input(s) and output(s) 606, which generally provide means for providing data to and from processing system 600, such as via connection to computing device peripherals, including user interface peripherals.

Processing system 600 further includes a memory 608 comprising various components. In this example, memory 608 includes an interface component 621 to generate and maintain an interface (such as, the interface 124 of FIG. 1 and FIG. 2) to provide audiovisual representations of characteristics of vehicles in a fleet (e.g., the vehicles 102 of FIG. 1) (e.g., charging characteristics, identifiers, assigned jobs, current SoC, charging deadline, etc.) and/or status alerts (e.g., alerts indicative of problems with charging of the vehicle, etc.). The memory 608 may also include a notification component 622 to provide notifications regarding alerts and/or alternative configurations via the interface and/or via other communication methods (e.g., text messages, emails, instant messages, automated voice messages, etc.). Further the memory 608 may include a communication component 623 to communicate with control systems (e.g., the EVFMS 106 and/or the CMSs 116 of FIG. 1) to provide output to the user (e.g., the fleet manager 115 of FIG. 1) from the control systems and input from the user to the control systems. The memory 608 may also include a parsing component 624 to communicate with the control systems and parse information received from the control systems to provide audiovisual representations of characteristics of vehicles, status alerts, and/or notifications has described herein.

Processing system 600 may be implemented in various ways. For example, processing system 600 may be implemented within on-site, remote, or cloud-based processing equipment. Note that in various implementations, certain aspects may be omitted, added, or substituted from processing system 600.

### Example Clauses

Implementation examples are described in the following numbered clauses:

Clause 1: A method for electric vehicle fleet management, the method comprising: detecting a trigger event that affects charging characteristics of at least one vehicle in a fleet; providing, via an interface, a prompt regarding the trigger event; presenting, via the interface, decisions to remedy the cause of the trigger event; providing, via the interface, consequences of the decisions to charging characteristics of one or more additional vehicles in the fleet; receiving, via the interface, an input accepting one of the decisions; providing the accepted decision to at least one of a fleet management system or a charge management system; and providing instructions that affect the operation of at least one charging station based on the accepted decision.

Clause 2: A method for electric vehicle fleet management, the method comprising: providing an interface to display charging session characteristics of one or more vehicles in a fleet; receiving, via the interface, an alternative configuration to the charging session characteristics of one of the vehicles; calculating one or more fleet effects to the charging session characteristics of the vehicles in the fleet caused by the alternative configuration; displaying, through the interface, the fleet effects; and upon receipt of acceptance to the alternative configuration, providing instructions to one or more charging stations associated with the one or more vehicles to implement the alternative configuration.

Clause 3: The method of Clause 2, the method comprising: providing an interface to display charging session characteristics of one or more vehicles in a fleet; receiving, via the interface, an alternative configuration to the charging session characteristics of one of the vehicles; calculating one or more fleet effects to the charging session characteristics of the vehicles in the fleet caused by the alternative configuration; displaying, through the interface, the fleet effects; and upon receipt of acceptance to the alternative configuration, providing instructions to one or more charging stations associated with the one or more vehicles to implement the alternative configuration.

Clause 4: The method of Clause 3, wherein the suggested changes include at least one of an optimization of an aggregate cost, an aggregate real cost, or aggregate emissions of a charging site.

Clause 5: The method of any of Clauses 2 through 4, wherein calculating the one or more fleet effects to the charging session characteristics includes maintaining a relative prioritization of charging sessions.

Clause 6: The method of any of Clauses 2 through 5, further comprising: determining and displaying external effects to the charging session characteristics of the vehicles caused by external sources; displaying, through the interface, the external effects; and upon receipt of the acceptance to the alternative configuration, providing instructions to the one or more charging stations associated with the one or more vehicles implement the external changes.

Clause 7: The method of Clause 6, wherein the external sources include: power availability.

Clause 8: The method of Clauses 2 through 7, wherein the charging session characteristics include one or more of: a finished charging time of a charging session; energy delivered during the charging session; cost of the charging session; maximum charging rate during the charging session; energy losses during the charging session; and greenhouse gas emissions during the charging session.

Clause 9: The method of Clause 2, wherein the alternative configuration to the charging session characteristics is a change in a relative prioritization of charging sessions.

Clause 10: A method comprising: determining, using an optimization model, a first charging strategy for a first vehicle and a second charging strategy for a second vehicle, the first vehicle having a first charging deadline and the second vehicle having a second charging deadline; modifying the first charging deadline; determining, using the optimization model, changes to the first charging strategy and the second charging strategy based on the modified first charging deadline; and providing instructions to implement the changes to the first charging strategy and the second charging strategy in response to the changes to the second charging strategy causing the vehicle to continue to meet the second charging deadline.

Clause 11: The method of Clause 10, wherein modifying the first charging deadline comprises modifying the first charging deadline to be an earliest feasible departure of the first vehicle.

Clause 12: The method of Clause 10, wherein modifying the first charging deadline comprises modifying the first charging deadline to be an earliest energy-aware departure of the first vehicle.

Clause 13: The method of Clause 10, wherein modifying the first charging deadline comprises modifying the first charging deadline to be an earliest timeline-aware departure of the first vehicle.

Clause 14: The method of Clause 10, wherein modifying the first charging deadline comprises modifying the first charging deadline to be an earliest cost-aware departure of the first vehicle.

Clause 16: The method of Clause 10, wherein determining, using the optimization model, changes to the first charging strategy and the second charging strategy based on the modified first charging deadline comprises determining a constrained energy delivery to the first vehicle and the second vehicle.

Clause 16: The method of Clause 10, wherein determining, based on the optimization model, changes to the first charging strategy and the second charging strategy based on the modified first charging deadline comprises determining an unconstrained energy delivery to the first vehicle and the second vehicle.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for electric vehicle fleet management, the method comprising:
detecting a trigger event that affects charging characteristics of at least one vehicle in a fleet;
providing, via an interface, a prompt regarding the trigger event;
presenting, via the interface, decisions to remedy the cause of the trigger event;
providing, via the interface, consequences of the decisions to charging characteristics of one or more additional vehicles in the fleet;
receiving, via the interface, an input accepting one of the decisions;
providing the accepted decision to at least one of a fleet management system or a charge management system; and
providing instructions that affect the operation of at least one charging station based on the accepted decision.

2. A method for electric vehicle fleet management, the method comprising:
providing an interface to display charging session characteristics of one or more vehicles in a fleet;
receiving, via the interface, an alternative configuration to the charging session characteristics of one of the vehicles;
calculating one or more fleet effects to the charging session characteristics of the vehicles in the fleet caused by the alternative configuration;
displaying, through the interface, the fleet effects; and
upon receipt of acceptance to the alternative configuration, providing instructions to one or more charging stations associated with the one or more vehicles to implement the alternative configuration.

3. The method of claim 2, further comprising:
determining suggested changes to the charging session characteristics of the vehicles, the suggested changes being based on the fleet effects;
displaying, through the interface, the suggested changes; and
upon receipt of the acceptance to the alternative configuration, providing instructions to the one or more charging stations associated with the one or more vehicles to implement the suggested changes.

4. The method of claim 3, wherein the suggested changes include at least one of an optimization of an aggregate cost, an aggregate real cost, or aggregate emissions of a charging site.

5. The method of claim 2, wherein calculating the one or more fleet effects to the charging session characteristics includes maintaining a relative prioritization of charging sessions.

6. The method of claim 2, further comprising:
determining and displaying external effects to the charging session characteristics of the vehicles caused by external sources;
displaying, through the interface, the external effects; and
upon receipt of the acceptance to the alternative configuration, providing instructions to the one or more charging stations associated with the one or more vehicles implement the external changes.

7. The method of claim 6, wherein the external sources include: power availability.

8. The method of claim 2, wherein the charging session characteristics include one or more of:
a finished charging time of a charging session;
energy delivered during the charging session;
cost of the charging session;
maximum charging rate during the charging session;
energy losses during the charging session; and
greenhouse gas emissions during the charging session.

9. The method of claim 2, wherein the alternative configuration to the charging session characteristics is a change in a relative prioritization of charging sessions.

10. A method comprising:
determining, using an optimization model, a first charging strategy for a first vehicle and a second charging strategy for a second vehicle, the first vehicle having a first charging deadline and the second vehicle having a second charging deadline;
modifying the first charging deadline;
determining, using the optimization model, changes to the first charging strategy and the second charging strategy based on the modified first charging deadline; and
providing instructions to implement the changes to the first charging strategy and the second charging strategy in response to the changes to the second charging strategy causing the first vehicle to continue to meet the second charging deadline.

11. The method of claim 10, wherein modifying the first charging deadline comprises modifying the first charging deadline to be an earliest feasible departure of the first vehicle.

12. The method of claim 10, wherein modifying the first charging deadline comprises modifying the first charging deadline to be an earliest energy-aware departure of the first vehicle.

13. The method of claim 10, wherein modifying the first charging deadline comprises modifying the first charging deadline to be an earliest timeline-aware departure of the first vehicle.

14. The method of claim 10, wherein modifying the first charging deadline comprises modifying the first charging deadline to be an earliest cost-aware departure of the first vehicle.

15. The method of claim 10, wherein determining, using the optimization model, changes to the first charging strategy and the second charging strategy based on the modified first charging deadline comprises determining a constrained energy delivery to the first vehicle and the second vehicle.

16. The method of claim 10, wherein determining, based on the optimization model, changes to the first charging strategy and the second charging strategy based on the modified first charging deadline comprises determining an unconstrained energy delivery to the first vehicle and the second vehicle.

17. A processing system, comprising:
a memory comprising computer-executable instructions; and
a processor configured to execute the computer-executable instructions and cause the processing system to perform at least the following:
detect a trigger event that affects charging characteristics of at least one vehicle in a fleet;
provide, via an interface, a prompt regarding the trigger event;
present, via the interface, decisions to remedy the cause of the trigger event;
provide, via the interface, consequences of the decisions to charging characteristics of one or more additional vehicles in the fleet;
receive, via the interface, an input accepting one of the decisions;
provide the accepted decision to at least one of a fleet management system or a charge management system; and
provide instructions that affect the operation of at least one charging station based on the accepted decision.

18. The processing system of claim 17, wherein the computer-executable instructions further cause the processing system to perform at least the following:
provide an interface to display charging session characteristics of one or more vehicles in the fleet;
receive, via the interface, an alternative configuration to the charging session characteristics of one of the vehicles;
calculate one or more fleet effects to the charging session characteristics of the vehicles in the fleet caused by the alternative configuration;
display, through the interface, the fleet effects; and
upon receipt of acceptance to the alternative configuration, provide instructions to one or more charging stations associated with the one or more vehicles to implement the alternative configuration.

19. The processing system of claim 18, wherein the computer-executable instructions further cause the processing system to perform at least the following:
determining suggested changes to the charging session characteristics of the vehicles, the suggested changes being based on the fleet effects;
displaying, through the interface, the suggested changes; and
upon receipt of the acceptance to the alternative configuration, providing instructions to the one or more charging stations associated with the one or more vehicles to implement the suggested changes.

20. The processing system of claim 18, wherein the computer-executable instructions further cause the processing system to perform at least the following:
determine and displaying external effects to the charging session characteristics of the vehicles caused by external sources;
display, through the interface, the external effects; and
upon receipt of the acceptance to the alternative configuration, providing instructions to the one or more charging stations associated with the one or more vehicles implement the external changes.
